(19) United States
(12) Patent Application Publication
(10) Pub. No.: US 2020/0154679 A1
(43) Pub. Date: May 21, 2020

(54) SYSTEMS AND METHODS FOR SENSING INSECT SEX OR SPECIES

(71) Applicant: Verily Life Sciences LLC, South San Francisco, CA (US)

(72) Inventor: Jianyi Liu, Santa Clara, CA (US)

(73) Assignee: Verily Life Sciences LLC, South San Francisco, CA (US)

(21) Appl. No.: 16/685,607

(22) Filed: Nov. 15, 2019

Related U.S. Application Data
(60) Provisional application No. 62/768,503, filed on Nov. 16, 2018.

(51) Int. Cl. A01K 29/00; G01N 21/84

(52) U.S. Cl. CPC A01K 29/005; A01M 99/00; G01N 2201/0612; G01N 21/84

(57) ABSTRACT

This disclosure relates to systems and methods for sensing insect sex or species. One example sensing system includes a light transmitter having a light emitter, and a light collimator positioned to receive light emitted by the light emitter, and collimate the received light; a light receiver positioned and oriented to receive the collimated light, the light receiver including a light detector, and a light decollimator positioned to receive collimated light from the light transmitter, and focus the received light onto the light detector; a non-transitory computer-readable medium; and a processor in communication with the non-transitory computer-readable medium, the processor configured to execute processor-executable instructions stored in the non-transitory computer-readable medium to: receive one or more signals from the light detector; and determine a wingbeat frequency of an insect traversing the collimated light based on the one or more signals.

### CROSS-REFERENCE TO RELATED APPLICATIONS

This application claims priority to U.S. Patent Application No. 62/768,503, filed Nov. 16, 2018, titled “Systems And Methods For Sensing Insect Sex Or Species,” the entirety of which is hereby incorporated by reference.

### FIELD

The present disclosure generally relates to insect sensing, and more specifically to systems and methods for sensing insect sex or species.

### BACKGROUND

All continents except Antarctica suffer from the plague of mosquito-vectored diseases. Various techniques for the control of mosquito populations involve the generation of sterile male insects for release into the wild for mating with local females. These techniques require systems for releasing the reared insects into the wild.

### SUMMARY

Various examples are described for systems and methods for sensing insect sex or species. One example sensing system includes a light transmitter having a light emitter, and a light collimator positioned to receive light emitted by the light emitter, and collimate the received light; a light receiver positioned and oriented to receive the collimated light, the light receiver including a light detector, and a light decollimator positioned to receive collimated light from the light transmitter, and focus the received light onto the light detector; a non-transitory computer-readable medium; and a processor in communication with the non-transitory computer-readable medium, the processor configured to execute processor-executable instructions stored in the non-transitory computer-readable medium to: receive one or more signals from the light detector; and determine a wingbeat frequency of an insect traversing the collimated light based on the one or more signals.

One example method includes emitting light, by a light emitter; collimating, by a light collimator, emitted light received from the light emitter; focusing, by a light decollimator, collimated light received from the light collimator; receiving, by a light detector, the focused light from the light decollimator; receiving, by a processor, one or more signals from the light detector; and determining, by the processor, a wingbeat frequency of an insect traversing the collimated light based on the one or more signals.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1A-1B and 2-4 show example systems for sensing insect sex or species;

FIGS. 5-7 show examples of light transmitters suitable for use with systems and methods for sensing insect sex or species;

FIG. 8 shows an example method for sensing insect sex or species; and

FIG. 9 shows an example computing device suitable for use with example systems and methods for sensing insect sex or species.

### DETAILED DESCRIPTION

Examples are described herein in the context of systems and methods for sensing insect sex or species. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

When breeding insects, such as for eventual release into a wild environment, it may be desirable to know the sex of each insect that has been reared, such as to enable sorting adult insects by sex. For example, in a sterile insect breeding program to reduce or eliminate a wild mosquito population, such as for Aedes aegypti mosquitos, male and female insect may be separated to prevent release of female insects into the environment. Releasing female insects may reduce the effectiveness of the program, thus they need to be segregated from the males, which are eventually released. However, because large amounts of mosquitos are reared and released, e.g., hundreds of thousands or more, manually determining the sex of each individual mosquito can be extremely time consuming or entirely impractical. Further, because it is critical that female mosquitos not be released in such programs, accurate sexing of each individual mosquito is needed.

To detect the sex, and in some cases the species, a sensing device is positioned to project collimated light across an enclosed insect pathway, such as an insect release tube or an entryway to an insect trap, such that insects traversing the tube pass through the collimated light. The collimated light is then focused on a sensor, such as a photodiode, which outputs a signal to a processor. Based on the received signal, the processor determines how much light was received by the sensor. Based on fluctuations in the received light, the processor can determine the presence of an insect and a wingbeat frequency of the insect and, using known wingbeat frequency information, the processor can count the number of insects that have traversed the insect pathway and determine the sex, and in some cases, the species, of each insect.

In this example, the sensing device employs a laser light source to emit light towards a concave lens. The concave lens spreads the emitted laser light towards a condenser lens. The condenser lens collimates the laser light and projects it across the insect pathway towards a second condenser lens. The combination of these two lenses—the concave lens and the condenser lens—generates a volume of collimated laser light within the insect pathway. The collimated laser light then arrives at the second condenser lens, which focuses the received collimated light onto a sensor, a single photodiode in this case. As discussed above, the photodiode outputs a signal to the processor based on the amount of received light.

In a steady state condition, e.g., when an insect is not present within the volume of collimated light, the collimated light projected across the insect pathway is substantially all received by the second condenser lens and focused onto the single photodiode. Thus, the photodiode receives substantially all of the light projected across the insect pathway at a substantially constant level, therefore generating a substantially constant output signal. When an insect flies into the volume of collimated light, it reduces the amount of light received by the photodiode, changing the photodiode's output signal. Further, because the insect is moving its wings, it not only obstructs some of the collimated light, the movement of its wings changes the amount of light that is obstructed in the time domain, causing a further change in the amount of light arriving at the photodiode. Thus, as the insect traverses the volume of collimated light, the photodiode produces a varying output signal that fluctuates based on the repetitive movement of the insect's wings.

The processor receives the outputted sensor signals and determines the wingbeat frequency, such as by performing a fast-Fourier transform (“FFT”) on the received sensor signal. The wingbeat frequency may then be used to determine whether the insect is male or female. Further, if the species of the insects is not known, the wingbeat frequency may also be used to identify the species of the insect.

This illustrative sensing device provides a high-quality sensor to detect wingbeat frequency of a flying insect using a single sensor element. Further, because collimated laser light is used—laser light provides highly parallel light rays—very little, if any, light received at the sensor is the result of reflections within the insect pathway. Further, because the speed of light is extremely fast, as opposed to techniques such involving sound waves (e.g., ultrasound), the few internal reflections that may occur have minimal impact on any sensor readings and a determined wingbeat frequency. Thus, this illustrative sensing device provides high-quality wingbeat frequency measurements using a relatively simple device.

This illustrative example is given to introduce the reader to the general subject matter discussed herein and the disclosure is not limited to this example. The following sections describe various additional non-limiting examples and examples of systems and methods for sensing insect sex or species.

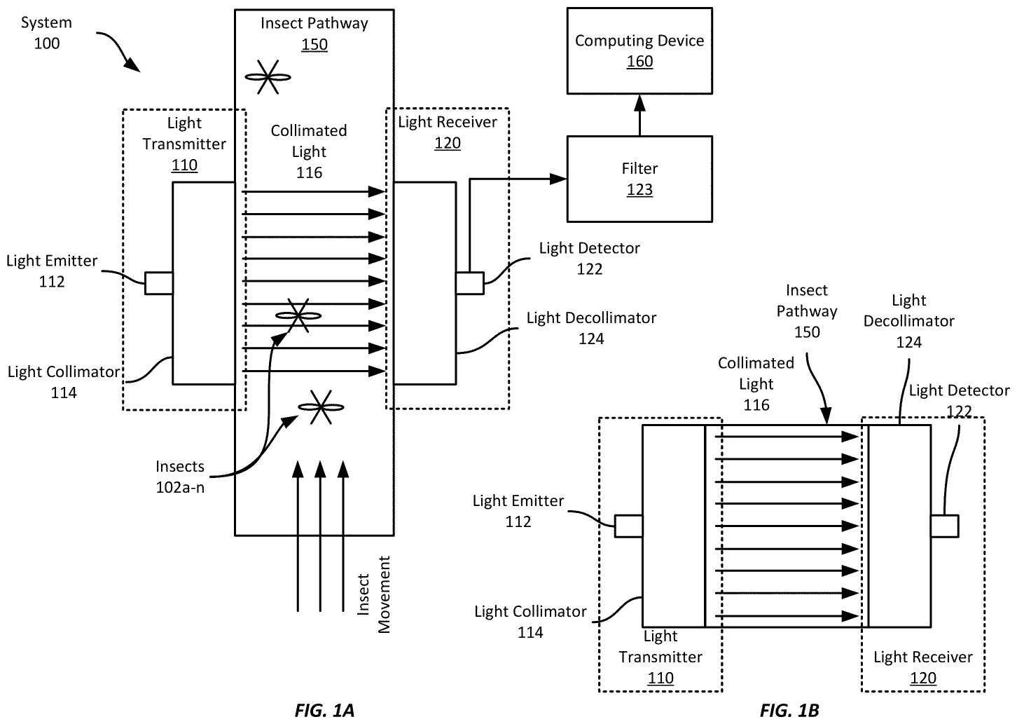

Referring now to FIGS. 1A-1B, FIG. 1A shows an example system for sensing insect sex or species. This example system 100 includes a light transmitter 110, which includes a light emitter 112 and light collimator 114, positioned on one side of an insect pathway 150, and a light receiver 120, which includes a light decollimator 130 and a light detector 122, positioned on the opposite side of the insect pathway 150. The insect pathway 150 in this example is a tube, but may be any suitable pathway across which collimated light may be emitted and received as described herein. In some examples, the pathway 150 may be enclosed to reduce noise from ambient light sources at the light detector 122.

The light detector 122 is in communication with the computing device 160 to provide sensor signals to the computing device that indicate an amount of light received by the light detector 122. In this example, the light detector 122 communicates its sensor signals to at least one filter 123, which provides filtered sensor signals to the computing device 160; however, in some examples, such a filter (or filters) is not employed.

In this example, the light emitter 112 is a laser light source. It is oriented to emit light across the insect pathway 150 towards the light receiver 120. It should be appreciated that any suitable laser light source may be employed; however, certain colors may be disfavored by one or more insect species. For example, mosquitos may dislike red-colored light, and thus a non-red-light emitting laser light source may be selected in applications involving mosquitos. Similarly, the power of the laser light source should be selected so as not to injure or kill any insects traversing the insect pathway. And while a laser light source is employed in this example, any suitable light source that emits light rays that may be shaped to form a highly parallelized volume of collimated light may be employed.

The light collimator 114 in this example includes two lenses; however any suitable arrangement of optical components to collimate emitted light may be employed. The first lens is a concave lens and the second lens is a condenser lens. The concave lens is positioned to receive light from the light emitter and to spread those light rays. The condenser lens receives the spread light rays from the concave lens and collimates them into a volume of collimated light 116 oriented to shine across the insect pathway 150. Specifically, in this example the volume of collimated light 116 entirely covers a cross-sectional portion of the insect pathway 150 such that any insect 102a-n that traverses the tube must travel through the volume of collimated light 116.

Referring now to FIG. 1B, FIG. 1B shows a cross-section of the insect pathway 150. The view in FIG. 1B is showing the interior volume down the length of the insect pathway with the direction of insect movement being into the page. As is shown in FIG. 1B, the collimated light 116 crosses the entire cross-sectional area of the insect pathway such that an insect traversing the insect pathway 150 must pass through the collimated light 116. Further, while the light transmitter 110 and light receiver 120 are both depicted as being located outside of the insect pathway 150 in this example, in some examples, either or both may be positioned within a wall of the insect pathway, or within an interior volume of the insect pathway 150. One such an arrangement may partially obstruct the pathway through the insect pathway 150 and form a neck through which the collimated light is transmitted and through which insects may travel to traverse the insect pathway 150.

Referring again to FIG. 1A, while in this example the light transmitter 110 includes only the two lenses described above, in some examples, the light transmitter 110 may include additional lenses to improve the light shaping to provide a highly collimated volume of light rays projected across the insect pathway. Further, one or more masks or filters may be positioned between the light emitter 112 and the light collimator 114 to provide light having a particular cross-sectional shape. For example, a laser diode may emit light having a substantially elliptical cross-section, e.g., an elliptical light beam; however, the lenses within the light collimator may have substantially circular cross-sections. While the elliptical light beam may be employed with such an arrangement, in some examples it may be desirable to provide a circular light beam to reduce or eliminate potential distortion of the light rays by the light collimator 114. Thus, a mask having a circular hole may be positioned between the light emitter and the light collimator 114 to only permit a circular light beam to reach the light collimator 114. Alternatively, a circular light beam may be created from the elliptical light beam using one or more lenses to stretch and focus the elliptical light beam into a circular light beam.

The light receiver 120 is positioned to receive substantially the entire light volume transmitted by the light transmitter 110 across the interior volume of the insect pathway 150. Thus, the light decollimator 124 is aligned with the light collimator 114 to receive the collimated light. In this example, the light decollimator 124 includes a condenser lens to receive the collimated light and to focus the received light onto the light detector 122; however, any suitable optical components may be employed to decollimate and focus the collimated light on to the light detector 122. Thus, in this example the light detector 122 is positioned at a focal point of the condenser lens to receive the focused light.

In this example, the light detector 122 is a single photodiode. However, any suitable light detector 122 may be employed in different examples. For example, a single photoresistor, a single phototransistor, or a single photocapacitor may be employed. Other types of light detectors may be used as well, such as charge-coupled devices, or CMOS-based sensors. In some examples, multiple light detectors 122 may be used. For example, a 2×2, or any M×N (where M and N may each be any positive integer), array of light detectors may be employed, though it should be appreciate that employing an array of light detectors may be limited based on an expected wingbeat frequency. For example, if an expected wingbeat frequency range is 400-800 Hz, a high-speed sensor array would be required as a more convention 60 Hz camera sensor would be inadequate. Further different types of light detectors may be employed to provide different types of sensor information. For example, one or more photodiodes or phototransistors may be employed to detect changes in received light, while one or more photoresistors may be used to detect a DC level of the received light, which may be used to subtract out ambient light signals. Such an arrangement may be suitable if a response time of a photoresistor is too slow to reliably detect variations in received light due to insect wingbeats.

Each of the light detectors may then be communicatively coupled to the computing device 160. The light detector 122 is configured to output signals to the computing device 160 indicating an amount of light detected by the light detector 122. In some examples, the sensor signal may be a voltage or a current. Though in some examples, the sensor may include a digital value, e.g., an 8-bit value between 0 and 255.

This example system 100 filters the sensor signals output by the light detector 122 by filter 123 before the computing device 160 determines insect sex or species. In this example, the filter 123 includes a low-pass filter coupled between the light detector 122 and the computing device. In one example, the light detector 122 outputs an analog sensor signal that is subsequently digitized, such as by an analog-to-digital converter (“ADC”). Before reaching the ADC, the analog sensor signal may be filtered by a low-pass filter based on the expected frequencies ranges of interest. For example, if an insect's wingbeat frequency is in the 500-1000 Hz range and the computing device 160 samples the ADC output at a rate of 20 kHz a low-pass filter with a cut-off frequency of 2 Hz may be used as an anti-aliasing filter. Such a filter may be established by setting a cut-off frequency at approximately 10-20% of the sampling frequency, so long as the cut-off frequency is sufficiently high to capture the sensor signal of interest. It should be appreciated that other types of filters may be used in addition to such an anti-aliasing filter, such as discussed below, e.g., to filter DC offsets within the sensor signal, etc.

In operation, and while no insect is present within the volume of collimated light 116, the light detector 122 outputs a substantially constant sensor signal. But when an insect enters the collimated light 116 and is moving its wings, the light detector 122 will receive a reduced total amount of light due to obstruction of some of the collimated light 116 by the body of the insect. In addition the amount of light will vary in the time domain based on the insect's wing movement. Thus, the light detector 122 will output a time-varying signal, which may include a DC offset (due to the relatively constant obstruction created by the insects body or ambient light). As discussed above, an anti-aliasing filter may first be employed to filter analog signals received from the light detector. In addition, filter 123 may filter the DC offset portion of the time-varying signal and provide substantially only the time-varying component of the signal. Example high-pass filters may be simple RC circuits, or may include more sophisticated arrangements to provide a higher quality time-varying signal or to filter, for example, noise due to poorly collimated light. Further, in some examples, the filter 123 may be implemented as software executed by the computing device 160. For example, a high-pass filter may be software-implemented and used to filter sensor signals received from the light detector 122 as discussed above. In some examples, other types of filters may be employed, such as a band-pass filter. For example, a band-pass filter centered on an expected frequency range may be employed.

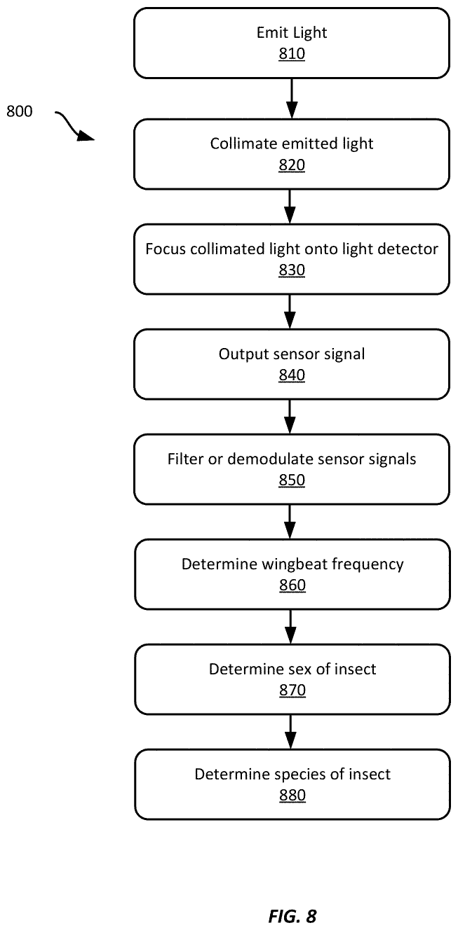

The computing device 160 receives the sensor signals from the light detector 122 and the filter 123 and determines when an insect is present within the collimated light and its wingbeat frequency based on the sensor signals. In addition, the computing device 160 may determine the species or sex of the insect based on the wingbeat frequency. Techniques for each of these features will be discussed in more detail below with respect to FIG. 8.

It should be appreciated that the sensing system 100 may not include the computing device 160 in some examples. For example, a sensing system 100 may be provided as the optical components, e.g., the light transmitter 110 and light receiver 120, that may then be later coupled with a computing device 160 and an insect pathway 150. Thus, a complete sensing system may not include the insect pathway or the computing device in some examples.

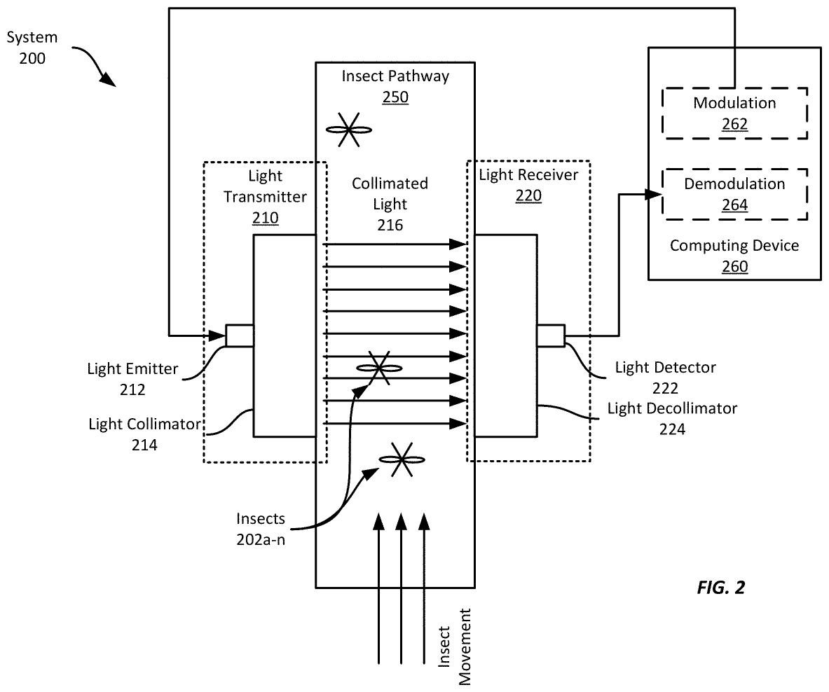

Referring now to FIG. 2, FIG. 2 shows an example system 200 for sensing insect sex or species. This example system 200 includes a light transmitter 210, which includes a light emitter 212 and light collimator 214, positioned on one side of an insect pathway 250, and a light receiver 220, which includes a light decollimator 230 and a light detector 222, positioned on the opposite side of the insect pathway 250. The light detector 222 is in communication with a computing device 260 to provide sensor signals to the computing device that indicate an amount of light received by the light detector 222. In this example, the light detector 222 communicates its sensor signals to at least one filter 123, which provides filtered sensor signals to the computing device 260. The components of this example system 200 are generally as described above with respect to FIGS. 1A-1B; however, in this example, the computing device 260 modulates the light emitted by the light emitter 212 and demodulates the incoming sensor signals from the light detector 222 to extract wingbeat frequency information.

To modulate the light, the computing device 260 outputs a signal to the light emitter 222 to change the amount of light emitted. For example, the computing device 260 may output a square wave at a predetermined frequency, e.g., 32 kHz, to rapidly turn the light emitter 212 on and off. Any suitable modulation signal, such as sine waves, square waves, etc. at any suitable frequency may be employed. Further, any suitable modulation scheme may be employed. To modulate the signal in this example, the computing device employs signal modulator 262 that includes a real-time clock driven by a quartz oscillator at 32 kHz, however, any suitable signal generator may be employed, such as a ripple counter, an internal clock signal (e.g., divided down) from the computing device's processor, a software loop, etc.

The light detector 222 will operate generally as discussed above with respect to FIGS. 1A-1B; however, because the light emitted by the light emitter is modulated, the signals output by the light detector 222 will have the same modulation characteristics. Thus, the light detector's signals may be received by a demodulator 264 at the computing device and demodulated using the same modulation signal output by the modulator 262, which enables synchronous demodulation of the light detector signals. In this example, the demodulator 264 is implemented in software, but in some examples, a hardware demodulator may be employed. Synchronous demodulation of the light detector signals will output a varying light signal based on the wingbeat frequency of any insect traversing the pathway 250 and passing through the collimated light 216; however, light from ambient light sources will not contribute to the outputted demodulated signal, thereby providing a high-quality varying signal representative of an insect's wingbeat. This wingbeat signal may then be used to determine a gender and species of the insect traversing the pathway.

It should be appreciated that while the modulator 262 and demodulator 264 are shown as components of the computing device 260, they may be separate standalone components or the modulator and demodulator may be incorporated into a single device to both modulate the light emitter and to demodulate information from signals output by the light detector 222. The demodulated information may then be transmitted or otherwise provided to the computing device 260 to count a number of insects traversing the pathway and to determine a sex or species of each insect.

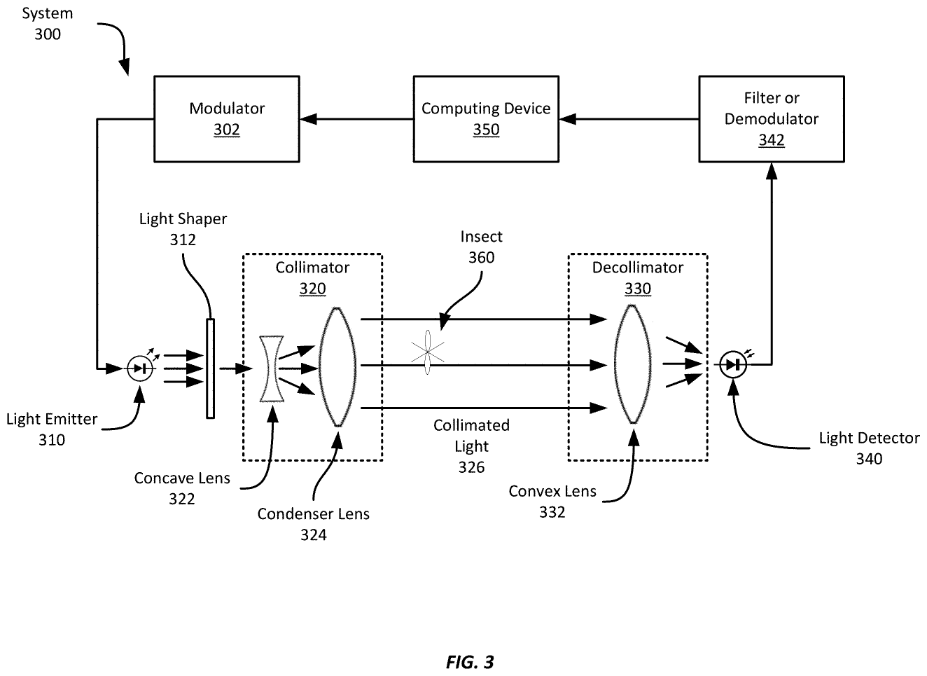

Referring now to FIG. 3, FIG. 3 shows an example system 300 for sensing insect sex or species. In this example, the system includes a light emitter 310, a light shaper 312, a collimator 320, a decollimator 330, and a light detector 340. The light emitter 310 and the light detector 340 are in communication with the computing device 350; however, as discussed above with respect to FIGS. 1A-1B, it should be appreciated that the sensing system 300 may not include the computing device 350 in some examples. In this example, the computing device 350 employs a modulator 302 to modulate light emitted by the light emitter 310, and the output of the light detector 340 is demodulated by a demodulator 342, as described in more detail below.

In this example, the light emitter 310 is a laser light source, such as a laser diode. While laser light sources typically emit light beams with low beam divergence, different laser light sources may generate light beams with different cross-sectional shapes. Thus, the example system 300 includes a light shaper 312 to create a light beam having a substantially circular cross-sectional shape from the light emitted by the light emitter 310. For example, laser diodes may output light beams having a elliptical shape. In some such examples, the light shaper may be a mask that only allows light within a circular cross-sectional area to pass through though light shaper 312. Alternatively, one or more lenses may be employed to adjust the shape of the emitted light beam to create a circular shape from the initial shape of the emitted light beam. In some examples, however, a light shaper 312 may not be used. At least some of the light emitted by the light emitter 310 then proceeds to the collimator 320, irrespective of whether a light shaper 312 is employed. It should be appreciated that in some examples the light emitter 310 may be modulated by the computing device 350 substantially as discussed above with respect to FIG. 2.

While a laser light source is employed in this example, any suitable light source may be employed so long as the light may be collimated by the collimator 320 to produce highly parallelized collimated light. Such highly parallelized light is directed towards the decollimator, which in turn focuses it for detection. Light that is not highly parallelized provides opportunities for reflections from interior surfaces of an insect pathway, thereby providing noise when ultimately received by the light detector 340. Further, badly collimated light may not arrive at the light detector at all, thus attenuating or eliminating the time-varying portion of the signal due to insect wingbeats. Thus, the less collimated the light projected across the insect pathway, the more noise is introduced into the light detector's signal. Thus, highly parallelized light is light that does not produce substantial optical noise at the light detector 340.

To emit light, the computing device 350 modulates the light emitted by the light emitter 310, by cycling the light emitter 310 on and off. In this example, the computing device employs signal modulator 302 that includes a real-time clock driven by a quartz oscillator at 32 kHz; however, any suitable signal generator may be employed, such as a ripple counter, an internal clock signal (e.g., divided down) from the computing device's processor, a software loop, etc.

In this example, the collimator 320 includes a concave lens 322 and a condenser lens 324. As shown in FIG. 3, the concave lens 322 is aligned with the condenser lens 324 to expand the received light beam from the light emitter 310 towards the condenser lens 324. In this example, the concave lens 322 is positioned so that substantially all of the light from the concave lens 322 is spread onto the condenser lens 324. The condenser lens 324 is positioned to receive the light beam spread from the concave lens 322 and generate a volume of collimated light 326.

It should be appreciated that the structure of the collimator 320 and decollimator 330 shown in FIG. 3 is only one example configuration. Other suitable configurations may be employed. For example, one or both convex lenses 324, 332 may be replaced by another type of lens, such as a Fresnel lens. Further, any suitable collimating lens configuration may be employed to collimate or decollimate the light rays emitted by the light source 310.

The decollimator 330 is positioned to receive substantially the entire volume of collimated light 326 from the collimator 320. In this example, the decollimator 330 includes a convex lens 332 that focuses the received collimated light 326 onto the light detector 340. To enable this, the light detector 340 is positioned at a focal point of the convex lens 332.

The light detector 340 in this example is a photodiode and receives the light focused by the decollimator 330; however, any suitable light detector(s) or combination of light detectors, such as those discussed above with respect to FIGS. 1A-1B may be employed. The light detector 340 transmits sensor signals to the computing device 350 indicating an amount of light received by the light detector 340.

The signals output by the light detector 340 in this example will be modulated based on the modulation scheme used by the modulator 302, discussed above. However, because the modulation scheme is known by the computing device 350, the demodulator 342 may synchronously demodulate the incoming sensor signals from the light detector 340. The demodulated signals may then be processed, e.g., using fast Fourier transforms (“FFT”) or discrete Fourier transforms (“DFT”), to extract wingbeat frequency information from the sensor signals. In some examples, filtering may be performed as well, such as by using a low-pass, band-pass, or high-pass filter according to the types of insects expected to be detected.

In some examples, such as examples that do not employ a modulator/demodulator configuration, the sensor signals from the light detector 340 are first filtered by an anti-aliasing filter as well as filter 342, which operates substantially as discussed with respect to the system 100 shown in FIG. 1. As discussed above, the filter or modulator 342 may be an electronic circuit, or it may be implemented in software at the computing device 350. In some examples, the filter 342 may include multiple filters, some of which may be electronic circuits while others may be implemented in software.

The computing device 350 receives the sensor signals and determines the presence of an insect and its wingbeat frequency. It can then determine a sex or species of the detected insect. In addition, the computing device 350 is in communication with the light emitter 310 and can activate or deactivate the light emitter 310, or change an intensity of the emitted light beam.

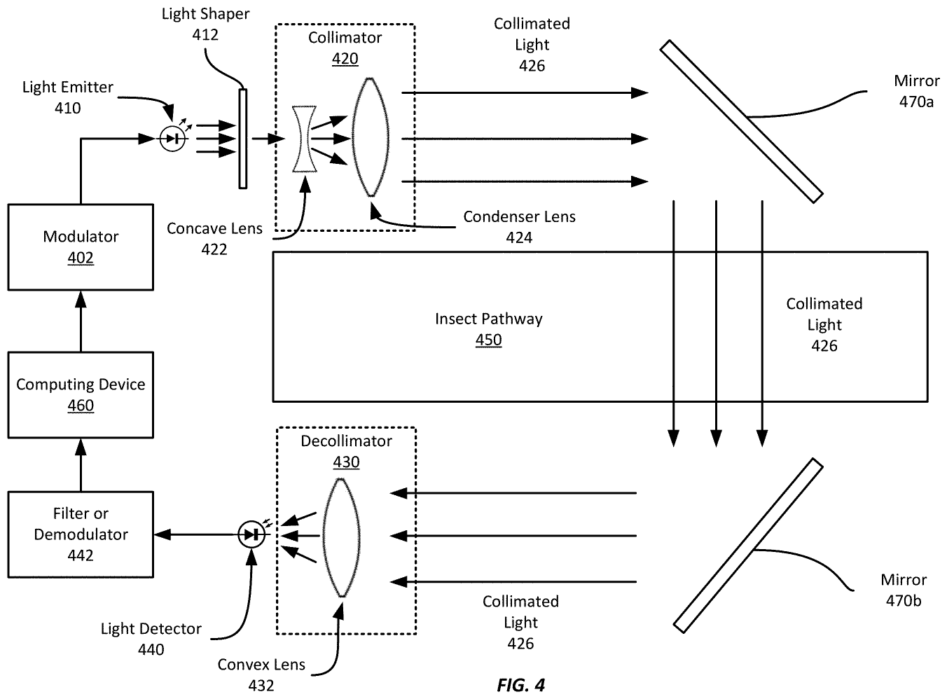

Referring now to FIG. 4, FIG. 4 shows an example system 400 for sensing insect sex or species. In this example, the system 400 includes a light emitter 410, light shaper 412, collimator 420, decollimator 430, light detector 440, filter or demodulator 442, a modulator 402, and computing device 460 substantially as described above with respect to FIGS. 1-3. However, this example system 400 also includes two mirrors 470a-b positioned to reflect the collimated 426 across the insect pathway 450. The mirrors 470a-b enable the light emitter 410 and the light detector 440 to be positioned at a location distant from the insect pathway 450 while still enabling insect sensing within the tube. Thus, the light emitter 410 (and related light transmitter components) and the light receiver 440 (and related light receiver components) can be potentially located at positions that may be more convenient for a user or other system components. Such an arrangement may also provide advantages in overall system size and packaging. In addition, because the physical dimensions of the system 400 may be reduced from the example shown in FIG. 1A, the system 400 may be less susceptible to vibration. It should be appreciated that in some examples the light emitter 410 may be modulated by the computing device 460 and the signals from the light detector 440 may be demodulated substantially as discussed above with respect to FIG. 2.

While in this example, two mirrors are employed, any suitable number of mirrors, (e.g., 1 or more), may be used to reflect the collimated light across the insect pathway 450 or to direct the collimated light to the decollimator 430 and light detector 440.

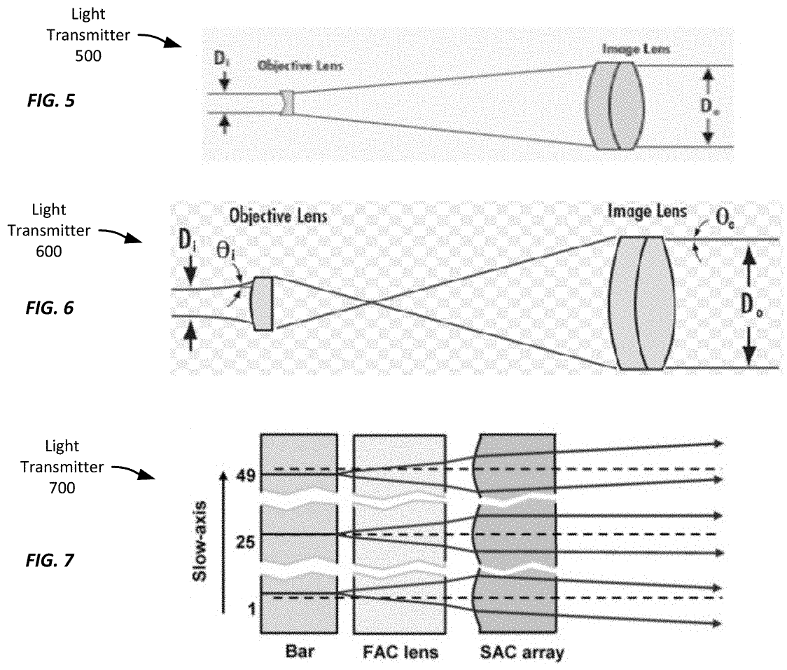

Referring now to FIG. 5, FIG. 5 shows example light transmitter. In this example, the light transmitter 500 includes an concave objective lens that expands incoming light rays, which are directed to the image lens, which collimates the light to provide a volume of collimated light.

FIG. 6 shows a similar light transmitter 600 that employs a convex lens to expand the incoming light rays. The image lens collimates the light to provide a volume of collimated light.

FIG. 7 shows an example light transmitter that employs one or more fast-axis collimation lenses in series with a corresponding slow-axis collimation lenses. The series combination of the axis collimators provides an expanded collimated volume of light rays. Further successive layers of alternating fast-axis and slow-axis collimation lenses may be used to expand the incoming light rays to any suitable volume of collimated light.

Referring now to FIG. 8, FIG. 8 shows an example method 800 for sensing insect sex or species. The example method 800 will be described with respect to the system 100 shown in FIG. 1; however, any suitable system according to this disclosure may be employed, such as the example system 200 shown in FIG. 2.

At block 810, the light emitter 112 emits light towards the light collimator 114. In some examples, the amount of light output by the light emitter may be modulated based on a modulation signal. For example, the computing device 260, using modulator 262, may output a square wave using a real-time clock to turn the light emitter on and off at a preset frequency, e.g., 32 kHZ. In some examples, the computing device 260, using modulator 262, may output a sine wave, an aperiodic signal, etc. to modulate the amount of light emitted by the light emitter.

At block 820, the light collimator 114 receives the light emitted by the light emitter 112 and collimates it. In this example, the light collimator also expands the cross-sectional area of the emitted light, such as by employing a concave lens between the light emitter and a condenser lens. The collimated light 116 is then projected across the interior volume of the insect pathway 150.

At block 830, the light decollimator 124 decollimates the received light and focuses it onto the light detector 122.

At block 840, the light detector 140 receives the focused light and outputs one or more sensor signals.

At block 850, the sensor signals 250 are filtered or demodulated. In this example, the filter is a high-pass filter electrically coupled between the light detector 122 (a photodiode in this example) and the computing device 160. While no insect is present within the volume of collimated light 116, the photodiode outputs a substantially constant current. But when an insect enters the light and is moving its wings, the photodiode will receive a reduced total amount of light due to obstruction of some of the light by the body of the insect. In addition the amount of light may vary in the time domain based on the insect's wing movement. Thus, the photodiode outputs a time-varying signal with a DC offset, in this example. The high-pass filter thus may filter the DC offset portion of the signal and provide substantially only the AC component of the signal. Example high-pass filters may be simple RC circuits, or may include more sophisticated arrangements to provide a higher quality time-varying signal or to filter, for example, noise due to poorly collimated light.

Further, in some examples, the filter 123 may be implemented as software executed by the computing device 160. For example, a high-pass filter may be software-implemented and used to filter sensor signals received from the light detector 122 as discussed above.

In some examples, the system 200 may demodulate information from the received one or more sensor signals. For example, the signals output by the light detector 222 may be received by a demodulator 264, which also receives the modulation signal from the modulator 262. The demodulator 264 may then demodulate information from the one or more sensor signals based on the modulation signal. Because the modulation signal is provided to the demodulator 264, the demodulator synchronously demodulates information from the received sensor signals. Further, in some examples the demodulated information may be further filtered using one or more filters, such as to filter out unwanted signals, such as flickering ambient lights (e.g., fluorescent lights), etc.

At block 860, the computing device 160 receives the sensor signals, which in this example have been filtered, and determines a wingbeat frequency based on the received sensor signals. In this example, the computing device 160 receives and samples the filtered AC signal from the light detector 122 and performs a FFT using the samples to obtain a frequency spectrum of the AC signal. Using the frequency spectrum determines the wingbeat frequency based on dominant frequency component(s) of the frequency spectrum. In some examples, the computing device 160 may obtain samples for the entire duration that the insect is within the volume of collimated light 116, though in some examples, it may only obtain samples for a predetermined period of time.

In some examples, the computing device 160 may first determine whether an insect is present within the volume of collimated light before determining a wingbeat frequency. For example, as discussed above, when no insect is present, the light detector 122 may output a substantially constant sensor signal. In this example, the filter 123 may filter the constant sensor signal and provide a substantially constant output, e.g., substantially zero. Thus, the computing device 160 may determine whether an insect is present based on whether the received filtered sensor signals are greater than a predefined threshold above (or below) a zero value. In some examples, the filter 123 may separate the DC portion of the signal from the time-varying portion of the signal and provide both signals to the computing device 160. Thus, the computing device 160 may receive two different sensor signals (or sets of sensor signals), one that may indicate whether or not an insect is present within the collimated light based on a level of the DC signal, while the other signal carries the time-varying signal and the computing device 160 can determine a wingbeat frequency based on the time-varying signal. In other examples, the computing device 160 may determine or learn a steady state value indicating that no insect is present and while the sensor signals indicate substantially the determined or learned value, the computing device 160 may determine no insect is present. However, if the steady state value drops, e.g., by a threshold amount, the computing device 160 may determine that an insect is present.

In some examples the computing device 160 may perform a FFT analysis on the received sensor signals and determine that no insect is present if the FFT indicates substantially only low frequencies, e.g., <100 Hz, as contributing to the received sensor signals, or if frequencies in an expected range for a particular insect species are not present. For example, if Aedes aegypti typically have wingbeat frequencies between 420-830 Hertz (“Hz”), then if no frequency peaks in this range are detected within the FFT output, then the computing device 160 may determine that no insect is present. Other threshold values may be used in some examples, including only a single threshold, which may indicate a minimum frequency below which the computing device 160 determines no insect is detected.

Examples that first determine whether an insect is present before performing a frequency analysis may reduce power consumption by preventing execution of computationally expensive tasks, such as FFT analysis, unless an insect is first detected.

At block 870, the computing device 160 determines a sex of the insect based on the determined wingbeat frequency. In this example, the computing device 160 accesses a lookup table having mapping information between wingbeat frequencies and insect sexes. For example, the lookup table may indicate lower and upper bounds for male and female insects of a particular species, or for multiple insect species. To determine the sex of the detected insect, the computing device 160 may use the determined wingbeat frequency to look up the corresponding sex of the insect. For example, a determined wingbeat frequency between 420 and 560 Hz may indicate a female Aedes aegypti mosquito, while a frequency between 570 and 835 Hz may indicate a male Aedes aegypti mosquito.

At block 880, the computing device 160 determines a species of the insect based on the determined wingbeat frequency. In this example, the computing device 160 accesses a second lookup table having mapping information between wingbeat frequencies and insect species. For example, the lookup table may indicate lower and upper bounds for Aedes aegypti mosquitoes, or it may include multiple frequency ranges associated with Aedes aegypti, as well as frequencies for other species. For example, the lookup table may include entries for Aedes aegypti corresponding to frequencies in the range of 570-832 Hz and 420-560 Hz, while other entries for the Anopheles quadrimaculatus mosquitos may have corresponding frequencies in the range of 320-480 Hz and 500-770 Hz.

To determine the species of the detected insect, the computing device 160 may use the determined wingbeat frequency to look up the corresponding species of the insect. The computing device 160 may then output the corresponding species, or the corresponding species and sex. In examples where multiple different insect species correspond to a determined wingbeat frequency, the computing device 160 may output all insect species (or species and sex combinations) corresponding to the determined wingbeat frequency. In some examples, however, the computing device 160 may output an error or an indication that the species (or species and sex) wasn't determinable. In some examples, the computing device 160 may continue to determine wingbeat frequency information until the insect exits the volume of collimated light or until a single insect species may be determined based on a detected wingbeat frequency.

The example method described above included certain features in a particular order. It should be appreciated that all such features are not required, nor is the particular order used. For example, filtering of the light detector signal at block 850 need not be performed, though in some examples, an anti-aliasing filter may be employed to provide accurate digitization of the sensor signals, though no other subsequent filtering may be employed. In addition, blocks 870 and 880 may be optional or may be performed outside of the context of an example system. For example, the system may simply output the wingbeat frequency without making any determination as to sex or species of a detected insect. Such an example may be associated with example systems that lack a computing device, e.g., computing device 160 or 250. In some examples, the method 800 may iterate over a period of time or indefinitely until the example system is deactivated. Further, blocks 870 and 880 may be reordered or performed substantially simultaneously. For example, the system may first determine a species of the insect and then determine a sex of the insect, or it may access a single lookup table that includes both sex and species information.

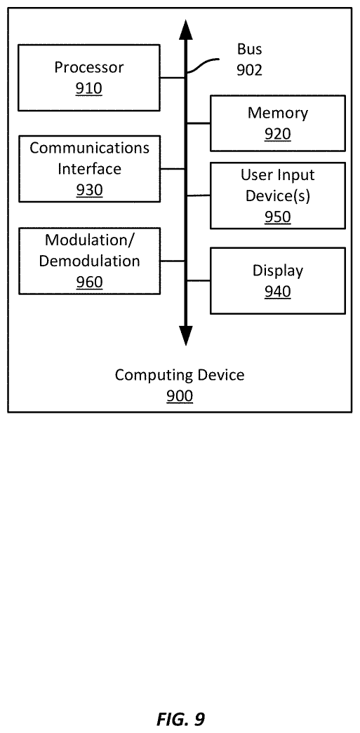

Referring now to FIG. 9, FIG. 9 shows an example computing device 900 suitable for use in example systems or methods for sensing insect sex or species according to this disclosure. The example computing device 900 includes a processor 910 which is in communication with the memory 920 and other components of the computing device 900 using one or more communications buses 902. The processor 910 is configured to execute processor-executable instructions stored in the memory 920 to perform one or more methods for sensing insect sex or species according to different examples, such as part or all of the example method 800 described above with respect to FIG. 8. The computing device, in this example, also includes one or more user input devices 950, such as a keyboard, mouse, touchscreen, microphone, etc., to accept user input. The computing device 900 also includes a display 940 to provide visual output to a user.

The computing device 900 also includes a communications interface 940. In some examples, the communications interface 930 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A sensing system comprising:
a light transmitter comprising:
a light emitter, and
a light collimator positioned to:
receive light emitted by the light emitter, and
collimate the received light;
a light receiver positioned and oriented to receive the collimated light, the light receiver comprising:
a light detector, and
a light decollimator positioned to:
receive collimated light from the light transmitter, and
focus the received light onto the light detector;
a non-transitory computer-readable medium; and
a processor in communication with the non-transitory computer-readable medium, the processor configured to execute processor-executable instructions stored in the non-transitory computer-readable medium to:
receive one or more signals from the light detector; and
determine a wingbeat frequency of an insect traversing the collimated light based on the one or more signals.

2. The sensing system of claim 1, further comprising:
a signal modulator communicatively coupled to the light transmitter, the signal modulator configured to output a modulation signal to modulate the amount of light emitted by the light emitter;
a signal demodulator communicatively coupled to the light receiver, the signal modulator configured to demodulate information obtained from the one or more sensor signals received from the light detector based on the modulation signal; and
wherein the determined wingbeat frequency is based on the demodulated information.

3. The sensing system of claim 2, wherein the signal modulator comprises a real-time clock.

4. The sensing system of claim 1, wherein the processor is further configured to execute processor-executable instructions stored in the non-transitory computer-readable medium to determine a sex of an insect based on the wingbeat frequency.

5. The sensing system of claim 1, wherein the processor is further configured to execute processor-executable instructions stored in the non-transitory computer-readable medium to determine a species of an insect based on the wingbeat frequency.

6. The sensing system of claim 1, further comprising a band-pass filter positioned to receive the one or more signals from the light detector, the band-pass filter configured to filter a steady-state signal from the one or more signals, and to provide the one or more filtered signals to the processor.

7. The sensing system of claim 1, wherein the light emitter is configured to emit light having a substantially circular cross-section.

8. The sensing system of claim 1, wherein the light emitter comprises a laser light source.

9. The sensing system of claim 8, wherein the laser light source comprises a laser diode.

10. The sensing system of claim 1, wherein the light detector is a single light detector.

11. The sensing system of claim 10, the single light detector is a photodiode, a phototransistor, a photoresistor, or a photocapacitor.

12. The sensing system of claim 1, wherein the light collimator comprises a concave lens and a condenser lens, the concave lens positioned to receive light from the light emitter, and the condenser lens positioned at a focal length from the concave lens to collimate light received from the concave lens.

13. The sensing system of claim 1, wherein the light decollimator comprises a convex lens and a condenser lens, the convex lens positioned to receive light from the condenser lens and to focus the received light onto the light detector, and the condenser lens positioned at a focal length from the convex lens to focus light received from the light collimator.

14. The sensing system of claim 1, further comprising a first mirror and a second mirror, wherein:
the first mirror is positioned to reflect the collimated light received from the light collimator;
the second mirror is positioned to reflect the collimated light reflected by the first mirror; and
the light decollimator receives the collimated light reflected by the second mirror.

15. A method comprising:
emitting light, by a light emitter;
collimating, by a light collimator, emitted light received from the light emitter;
focusing, by a light decollimator, collimated light received from the light collimator;
receiving, by a light detector, the focused light from the light decollimator;
receiving, by a processor, one or more signals from the light detector; and
determining, by the processor, a wingbeat frequency of an insect traversing the collimated light based on the one or more signals.

16. The method of claim 1, further comprising:
modulating, using a modulation signal, the amount of light emitted by the light emitter;
demodulating information obtained from the one or more sensor signals received from the light detector based on the modulation signal; and
wherein determining the wingbeat frequency is based on the demodulated information.

17. The method of claim 16, wherein the modulation signal is output by a real-time clock.

18. The method of claim 15, further comprising determining a sex of an insect based on the wingbeat frequency.

19. The method of claim 15, further comprising determining a species of an insect based on the wingbeat frequency.

20. The method of claim 15, wherein the light emitter is configured to emit light having a substantially circular cross-section.

21. The method of claim 15, further comprising:
filtering, using a band-pass filter positioned to receive the one or more signals from the light detector, a steady-state signal from the one or more signals, and
providing the one or more filtered signals to the processor.

22. The method of claim 15, wherein the light emitter comprises a laser light source.

23. The method of claim 22, wherein the laser light source comprises a laser diode.

24. The method of claim 15, wherein the light detector is a single light detector.

25. The method of claim 24, the single light detector is a photodiode, a phototransistor, a photoresistor, or a photocapacitor.

26. The method of claim 15, wherein the light collimator comprises a concave lens and a condenser lens, the concave lens positioned to receive light from the light emitter, and the condenser lens positioned at a focal length from the concave lens to collimate light received from the concave lens.

27. The method of claim 15, wherein the light decollimator comprises a convex lens and a condenser lens, the convex lens positioned to receive light from the condenser lens and to focus the received light onto the light detector, and the condenser lens positioned at a focal length from the convex lens to focus light received from the light collimator.

28. The method of claim 15, further comprising a first mirror and a second mirror, wherein:
the first mirror is positioned to reflect the collimated light received from the light collimator;
the second mirror is positioned to reflect the collimated light reflected by the first mirror; and
the light decollimator receives the collimated light reflected by the second mirror.
